(19) United States
(12) Patent Application Publication
(10) Pub. No.: US 2025/0128224 A1
(43) Pub. Date: Apr. 24, 2025

(54) OXIDATION REACTOR FOR PARTIAL OXIDATION OF A FEED STREAM

(71) Applicant: L'Air Liquide, Société Anonyme pour l'Etude et l'Exploitation des Procédés Georges Claude, Paris (FR)

(72) Inventor: Antonio COSCIA, Frankfurt am Main (DE)

(21) Appl. No.: 18/919,405

(22) Filed: Oct. 17, 2024

(30) Foreign Application Priority Data
Oct. 20, 2023 (EP) 23204771

(51) Int. Cl. B01J 8/06; C01B 3/04; C01B 3/36; C01B 3/38

(52) U.S. Cl. CPC B01J 8/065; B01J 8/067; C01B 3/047; C01B 3/363; C01B 3/386; B01J 2208/00194; B01J 2208/00504; C01B 2203/0255; C01B 2203/0261; C01B 2203/0811; C01B 2203/0883; C01B 2203/1235

(57) ABSTRACT

The invention relates to an oxidation reactor for partial oxidation of a feed stream with an oxygen-containing oxidant stream to give a hydrogen-containing product stream. This partial oxidation may be conducted as a noncatalytic partial oxidation (POX) or as an autothermal reforming (ATR). Useful feed streams here include hydrocarbonaceous streams, but also ammonia-containing streams. According to the invention, the oxidation reactor is equipped with multiple cooling zones surrounding the reactor shell. As a result, operation of the oxidation reactor can continue if, for example, merely an inspection or repair at a particular point in the reactor shell is required. Operation of the oxidation reactor can continue over the duration of the inspection or repair measures, such that production shutdowns are avoided.

### CROSS REFERENCE TO RELATED APPLICATIONS

This application claims the benefit of priority under 35 U.S.C. § 119 (a) and (b) to European Patent Application No. 23204771, filed Oct. 20, 2023, the entire contents of which are incorporated herein by reference.

### FIELD OF THE INVENTION

The invention relates to an oxidation reactor for partial oxidation of a feed stream with an oxygen-containing oxidant stream to give a hydrogen-containing product stream. This partial oxidation may be conducted as a noncatalytic partial oxidation (POX) or as an autothermal reforming (ATR). Useful feed streams here include hydrocarbonaceous streams, but also ammonia-containing streams.

The invention further relates to a process for producing a crude synthesis gas stream from a feed stream containing hydrocarbons and an oxygen-containing oxidant stream by noncatalytic partial oxidation or by autothermal reforming, and to a process for producing a product stream containing hydrogen and nitrogen from an ammonia-containing feed stream and an oxygen-containing oxidant stream.

### PRIOR ART

Synthesis gases are gas mixtures containing hydrogen and carbon oxides which are used in various synthesis reactions. Examples thereof are methanol synthesis, the production of ammonia by the Haber-Bosch process or Fischer-Tropsch synthesis. Conventional routes for production of hydrogen-containing synthesis gases include steam reforming, autothermal reforming (ATR) and noncatalytic partial oxidation (POX), in each case using hydrocarbonaceous feed materials as reactant streams. ATR and POX are conducted in oxidation reactors of similar construction that differ essentially by the presence of a catalyst layer in the lower portion of the oxidation reactor in the autothermal reformer.

The partial oxidation of hydrocarbonaceous feed material for production of synthesis gas is typically performed at high reactor temperatures in the range from 1000° C. to 1500° C. and pressures of up to 100 bara. Oxidation reactors used for noncatalytic partial oxidation (POX reactors) are often refractorily lined reactors with hemispherical or virtually hemispherical domes. The partial oxidation burner (POX burner) is generally mounted at the top of the dome and serves for introduction of the hydrocarbonaceous feed material, the oxygen-containing oxidant and—optionally—one or more moderator streams.

The industrial processes and apparatuses for partial oxidation known from the prior art propose various apparatuses for introducing and mixing the various streams, i.e. the hydrocarbonaceous feed material, a generally oxygen-containing oxidant and sometimes a moderator. The moderator used is frequently carbon dioxide (CO₂) or steam, where the moderator is separately introduced into the reactor via a separate channel within the burner or admixed with one or more of the other feed streams upstream of the burner. The oxidant used is typically air, enriched air or pure oxygen (comprising at least 95 mol % of oxygen). A hydrocarbonaceous feed stream is a stream containing hydrocarbons such as methane or higher hydrocarbons or other hydrogen-and carbon-containing molecules (for example alcohols such as methanol, ethanol). This may also be a stream derived from an upstream primary reformer which contains not only carbon monoxide (CO), hydrogen (H₂), CO₂ and water (H₂O) but also hydrocarbons such as methane, ethane, ethylene or higher hydrocarbons such as benzene, toluene or xylenes. The hydrocarbonaceous feed material and the oxidant are generally mixed in a reactor in close proximity to the injection nozzles.

The basic construction and the use of oxidation reactors of the type described are known per se from the literature and are described, for example, in the article “Gas Production”, Ullmann's Encyclopedia of Industrial Chemistry, Sixth Edition, 1998 Electronic Release, in chapter 2.5 “Autothermal Catalytic Reforming” and chapter 3 “Noncatalytic Partial Oxidation”. Both reactor types have a pressure-rated reactor shell which is made of a generally metallic material and which is lined on its inside with one or more layers of refractory material, for example refractory bricks, which thus form protective layers against the heat released in the reactor interior and against any corrosive gas constituents.

Another output stream for production of a hydrogen-containing gas which is proposed in the more recent literature is an ammonia-containing feed stream, which is reacted with an oxygen-containing oxidant stream and optionally a steam stream to give a hydrogen-containing product gas. This reaction can in turn be effected, for example, by the principle of noncatalytic partial oxidation or by the principle of autothermal reforming in respectively suitable oxidation reactors.

Oxidation reactors of the type specified are usually cooled on the outside in order to increase the service lives of the construction materials used for the oxidation reactor and to improve energy recovery. For this purpose, the oxidation reactor is surrounded by a cooling shell through which a fluid cooling medium flows, often water under pressure. For this purpose, the cooling medium is introduced into the cooling shell in cold form, absorbs a portion of the enthalpy of reaction released within the reactor, and is discharged from the cooling shell in heated form. The heated cooling medium is then cooled by means of one or more coolers and guided back into the cooling shell in cooled form, forming a cooling media circuit. The amount of heat withdrawn from the heated cooling medium in the course of cooling can be recovered by indirect heat exchange.

A disadvantage of the procedure described is that, with the method of construction of the oxidation reactors that has been customary to date, operation thereof, even for a short duration, is fundamentally only possible with a cooling system in operation. This means that the oxidation reactor has to be shut down completely if the cooling system fails or the cooling shell has to be disassembled for repair or inspection work on the outside of the reactor shell. This leads to added costs owing to the corresponding stoppage of production in the oxidation reactor.

It is therefore an object of the present invention to specify an oxidation reactor for partial oxidation of a feed stream with an oxygen-containing oxidant stream to give a hydrogen-containing product stream, which does not have the mentioned disadvantages of the oxidation reactors that are known from the prior art.

In further aspects, the object is achieved by further configurations of the invention that will be apparent from the dependent claims of the respective category.

An oxygen-containing oxidant means any oxygen-containing fluid, for example pure oxygen in any purity, air or any other fluid capable of supplying oxygen to a carbon-containing reactant.

A means is an article which makes it possible to achieve, or is helpful in achieving, an objective. Means of performing a particular process step should in particular be considered to mean all physical objects which a person skilled in the art would consider for performance of this process step. For example, a person skilled in the art will consider means of introducing or discharging a material stream to include all transporting and conveying apparatuses, i.e. for example pipe conduits, pumps, compressors, valves, which appear to be necessary or sensible for performance of this process step on the basis of their knowledge in the art.

In the context of the present description, steam is a synonym for water vapour, unless stated otherwise in the individual case. By contrast, the term “water” relates to water in the liquid state, unless stated otherwise in the individual case.

If required, pressures are specified in absolute pressure units, bara or bar(a) for short, or in gauge pressure units, barg or bar(g) for short, unless stated otherwise in the individual case.

A fluid connection between two regions of the apparatus or plant according to the invention means any type of connection which makes it possible for a fluid, for example a gas stream, to be able to flow from one to the other of the two regions, neglecting interposed regions or components. A direct fluid connection should in particular be considered to mean any type of connection which makes it possible for a fluid, for example a gas stream, to flow directly from one to the other of the two regions without any other interposed regions or components, except for pure transportation operations and the means required therefor, for example pipe conduits, valves, pumps, compressors, reservoirs. One example would be a pipe conduit leading directly from the one to the other of the two regions.

“Optionally” or “electively” means that the subsequently described event or circumstances may or may not occur or that a feature may or may not be present. The description encompasses cases in which the event or circumstance occurs and cases in which it does not occur. The description likewise encompasses cases in which a feature is present or is not present.

The conditions of noncatalytic partial oxidation and of autothermal reforming are known to the person skilled in the art from the prior art, for example the documents discussed at the outset. These are the physicochemical conditions under which a measurable, preferably an industrially relevant, conversion of fluid or fluidized carbon-containing feed streams to synthesis gas products is achieved. These include, as important parameters, the establishment of a suitable partial oxidation temperature of typically about 1000° C. or above. It is especially characteristic for noncatalytic partial oxidation that no catalyst is present in the partial oxidation reactor. By contrast, it is a characteristic feature of autothermal reforming that a layer of a specific ATR catalyst, but one which is known per se and commercially available, is present in the lower portion of the oxidation reactor.

Necessary adjustments of the conditions of the noncatalytic partial oxidation and of the autothermal reforming to the respective operating requirements will be made by the person skilled in the art on the basis of routine experiments. Any specific reaction conditions disclosed may serve as a guide, but should not be considered to be limiting in relation to the scope of the invention.

In order to avoid a fracture owing to the thermal circumferential expansion of the protective layers, in the case of multilayer linings of oxidation reactors with refractory bricks, clear spaces in the form of annular gaps are frequently provided between the different protective layers or between protective layer and reactor shell (expansion gaps in the form of annular gaps), which offer sufficient space for thermal expansion in radial direction. Alternatively or additionally, periodic expansion joints may be provided in each brick layer (periodically circumferential expansion gaps) and/or between the brick layers (expansion gaps in longitudinal direction). Also possible are combinations of periodically circumferential expansion gaps, expansion gaps in longitudinal direction and expansion gaps in the form of annular gaps.

The terms “entry”, “inlet”, “exit” and “outlet” relate to the flow direction of the feed materials through the oxidation reactor.

The invention is based on the finding that the disadvantages of the oxidation reactors known to date from the prior art can be circumvented when the oxidation reactor is equipped with multiple cooling zones surrounding the reactor shell. As a result, operation of the oxidation reactor can continue if, for example, merely an inspection or repair at a particular point in the reactor shell is required. In this case, it is only that cooling zone which surrounds the affected point in the reactor shell that is taken out of operation, and then disassembled. On completion of inspection or repair, this cooling zone is reassembled and put back into operation. Operation of the oxidation reactor can continue over the entire duration of the inspection or repair measures, such that production shutdowns are avoided.

It is also advantageous that the inventive presence of two or more cooling zones, for example two or more cooling zones disposed over the length of the oxidation reactor, enables better reaction to different production of heat along the longitudinal axis of the oxidation reactor. For instance, it would be possible in an illustrative configuration of the oxidation reactor as ATR to distinguish the heat budget in the upper burner portion of the oxidation reactor from that in the lower reactor portion comprising the ATR catalyst bed. With the inventive configuration of the oxidation reactor with multiple cooling zones, finer reaction to such differences is possible, and so the result is improved temperature control of the oxidation reactor.

A second aspect of the invention is characterized in that the first and second cooling zones are operable separately and can be assembled and disassembled separately. As a result, in one example, operation of the oxidation reactor can continue if, for example, merely an inspection or repair at a particular point in the reactor shell is required. Operation of the oxidation reactor can continue over the duration of the inspection or repair measures, such that production shutdowns are avoided.

A third aspect of the invention is characterized in that the flow of the cooling medium through the first and second cooling zones is controllable separately. In this way, finer reaction to local differences in the heat budget of the oxidation reactor is possible, and so the result is improved temperature control of the oxidation reactor.

A fourth aspect of the invention is characterized in that the pressure of the cooling medium in the first and second cooling zones is controllable separately. In this way too, finer reaction to local differences in the heat budget of the oxidation reactor is possible, and so the result is improved temperature control of the oxidation reactor. For example, it would be possible to operate one cooling zone with boiling cooling medium, which results in particularly intense heat transfer, while the cooling medium in a further cooling zone remains as a monophasic fluid.

A fifth aspect of the invention is characterized in that a common first and second fluid cooling medium is used, which flows through the first and second cooling zones. The use of a common cooling medium simplifies the configuration of the coolant circuit.

A sixth aspect of the invention is characterized in that the first and second cooling zones are in fluid connection, and in that the mass flow of the cooling medium through the first and second cooling zones is controllable separately. This configuration combines the advantages of a simplified coolant circuit with improved temperature control of the oxidation reactor.

A seventh aspect of the invention is characterized in that a cooling apparatus for intermediate cooling of the cooling medium is present between the first and second cooling zones. This configuration is advantageous when the cooling media in both cooling zones are to remain monophasic fluids, but high removal of heat from the first cooling zone is nevertheless required.

An eighth aspect of the invention is characterized in that more than two cooling zones are present. Although this configuration increases construction complexity, even finer reaction is possible in this way to local differences in the heat budget of the oxidation reactor, so as to result in a further improvement in temperature control of the oxidation reactor.

A ninth aspect of the invention is characterized in that a common cooling medium that flows through all cooling zones is used, where water is preferably used as the common cooling medium. Water is available in sufficient volume and quality at most locations, is nontoxic, and has advantages if cooling is to be implemented in the form of evaporative cooling in the particular cooling zone. The use of a common cooling medium additionally simplifies the configuration of the coolant circuit.

A tenth aspect of the invention is characterized in that the inlet end is of frustoconical configuration and has a gastight connection to the burner at its narrow end and has a gastight connection to the reactor shell at its wide end.

An eleventh aspect of the invention is characterized in that the thermal conductivity of the first protective layer is lower than the thermal conductivity of the second protective layer. What is advantageous about this configuration is the attenuating effect of the smaller thermal conductivity of the first protective layer on the heating of the reactor shell, especially when one or more cooling zones are not in operation.

A twelfth aspect of the invention is characterized in that a multitude of expansion gaps are present within the first and/or second protective layer, and are preferably distributed uniformly over the circumference and/or length of the first and/or second protective layer. In this way, damage to the protective layers as a result of thermal expansion is avoided.

A thirteenth aspect of the invention is characterized in that an expansion gap in the form of an annular gap is disposed between the reactor shell and the first protective layer and/or between the first protective layer and the second protective layer. In this way, damage to the protective layers as a result of thermal expansion is avoided.

A fourteenth aspect of the invention is characterized in that the wall thicknesses and/or thermal conductivities of the first and second protective layers are chosen such that the temperature of the reactor shell at its outer surface is between 180 and 300° C., preferably between 200 and 250° C., if no cooling medium is passed through one or more cooling zones. These stated temperatures are advantageous because energy consumption, material stress and heat exposure of operating personnel are reduced.

A fifteenth aspect of the invention is characterized in that water is used as a common cooling medium and in that the wall thicknesses and thermal conductivities of the first and second protective layers and the mass flow of the common cooling medium through the cooling zones are chosen such that the temperature of the cooling medium exiting from the cooling zones is less than 100° C. This limiting temperature is advantageous because energy consumption, material stress and heat exposure of operating personnel are reduced. In the case of disassembly of one or more cooling zones, in this way, the risk of burning for operating personnel as a result of unintentional contact with the exposed reactor shell is reduced.

A sixteenth aspect of the invention is characterized in that a portion of the reaction chamber is filled with a bed of a solid particulate catalyst active in respect of autothermal reforming (ATR).

A seventeenth aspect of the invention relates to the use of an oxidation reactor according to Claims 1 to 15 for noncatalytic partial oxidation (POX) of a feed stream containing hydrocarbons to a product stream containing hydrogen and carbon oxides.

An eighteenth aspect of the present invention relates to the use of an oxidation reactor according to Claim 16 for autothermal reforming (ATR) of a feed stream containing hydrocarbons to a product stream containing hydrogen and carbon oxides.

A nineteenth aspect of the invention relates to the use of an oxidation reactor according to Claims 1 to 15 for partial oxidation of an ammonia-containing feed stream to a product stream containing hydrogen and nitrogen.

A twentieth aspect of the invention relates to a process for producing a product stream containing hydrogen and carbon oxides from a feed stream containing hydrocarbons and an oxygen-containing oxidant stream.

A twenty-first aspect of the invention relates to a process for producing a product stream containing hydrogen and carbon oxides from a feed stream containing hydrocarbons and an oxygen-containing oxidant stream.

A twenty-second aspect of the invention relates to a process for producing a product stream containing hydrogen and nitrogen from an ammonia-containing feed stream and an oxygen-containing oxidant stream.

### BRIEF DESCRIPTION OF THE DRAWINGS

Developments, advantages and possible uses of the invention will also be apparent from the description of working examples that follows and the drawings. The invention is formed by all of the features described and/or depicted, either on their own or in any combination, irrespective of the way they are combined in the claims or the dependency references therein.

The figures show:

FIG. 1 a schematic diagram of a first configuration of the oxidation reactor according to the invention;

FIG. 2 a schematic diagram of a second configuration of the oxidation reactor according to the invention;

FIG. 3 a schematic diagram of a third configuration of the oxidation reactor according to the invention;

FIG. 4 a schematic diagram of a fourth configuration of the oxidation reactor according to the invention.

### DETAILED DESCRIPTION OF THE PREFERRED EMBODIMENTS

What is meant by “not shown” hereinafter is that an element in the figure under discussion is not represented graphically but is nevertheless present.

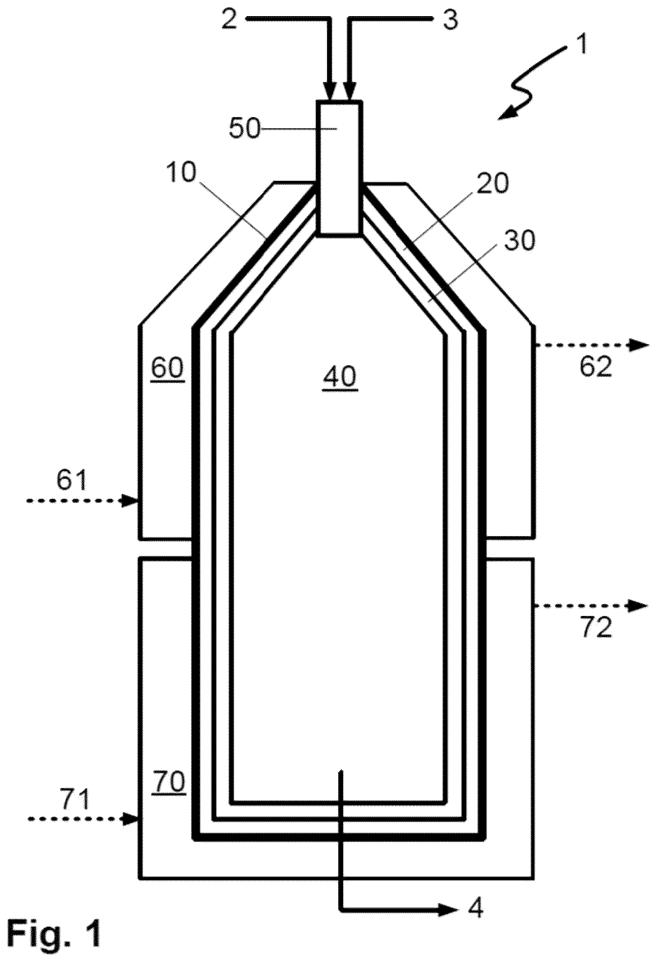

FIG. 1 shows a schematic diagram of a first configuration of the oxidation reactor 1 for partial oxidation of a feed stream with an oxygen-containing oxidant stream to give a hydrogen-containing product stream according to the invention. The oxidation reactor comprises a pressure-rated reactor shell 10 consisting of a metallic material, which is of cylindrical configuration over part of its length and has a first wall thickness. Within the reactor shell is mounted a first protective layer 20 composed of a first refractory material having a second wall thickness. Within the first protective layer is mounted a second protective layer 30 composed of a second refractory material having a third wall thickness. Within the second protective layer there is a void volume 40 as reactor chamber.

At an inlet end of the reactor shell 10 is mounted an inlet for the feed stream, where the inlet is configured as a burner 50 through which a feed stream is introduced into the oxidation reactor 1 via a conduit 2, and an oxygen-containing oxidant stream via a conduit 3. It is optionally possible to introduce a moderator stream comprising steam and/or carbon dioxide into the oxidation reactor via conduit 2 or conduit 3 or a separate conduit which is not shown, or a combination of at least two of these conduits.

At an outlet end of the reactor shell is mounted a conduit 4 as outlet, through which the product stream can be discharged. The connection of the conduit 4 to the reaction chamber is shown merely in schematic form, and technical details are not shown. However, it will be clear to the person skilled in the art how this connection should be configured.

Mounted on the reactor shell 10 is a first cooling zone 60 configured such that it surrounds the reactor shell 10, and such that, with the aid thereof, a first section of the reactor shell 10 is coolable by means of a first fluid cooling medium which is introduced into the first cooling zone 60 via a conduit 61 in the cold state, and which-after absorbing a portion of the amount of heat released in the oxidation reactor-is discharged from the first cooling zone 60 via a conduit 62 in the heated state.

Also mounted on the reactor shell 10 is a second cooling zone 70 configured such that it surrounds the reactor shell 10, and such that, with the aid thereof, a second section of the reactor shell 10 is coolable by means of a second fluid cooling medium which is introduced into the second cooling zone 70 via a conduit 71 in the cold state, and which-after absorbing a further portion of the amount of heat released in the oxidation reactor-is discharged from the second cooling zone 70 via a conduit 72 in the heated state.

The cooling medium heated in the first and/or second cooling zone 60, 70 is then cooled by means of one or more coolers (not shown) and conducted in cooled form back into the first and/or second cooling zone 60, 70, which forms one or more cooling media circuits. The amount of heat withdrawn from the heated cooling medium in the course of cooling can be recovered by indirect heat exchange and used, for example, as process heat in a neighbouring plant.

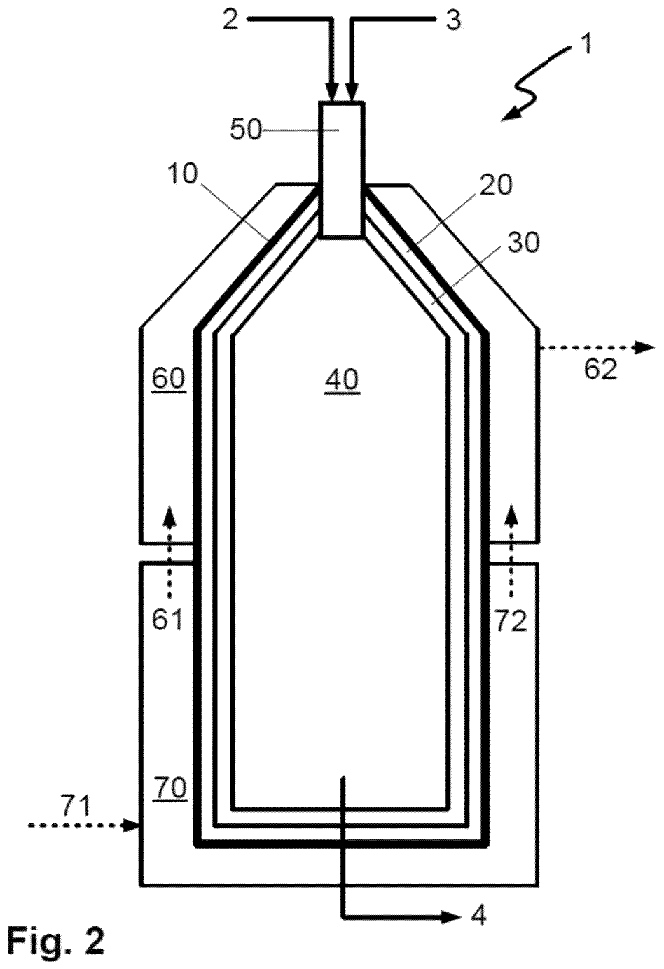

FIG. 2 shows a schematic diagram of a second configuration of the oxidation reactor according to the invention. Identical reference numerals denote elements of the oxidation reactors shown in the figures that have the same function and structure, unless stated otherwise in the individual context. Fundamentally, the configurations shown in FIGS. 2, 3 and 4 correspond to those that were elucidated in association with FIG. 1; differences will be pointed out separately.

By contrast with the embodiment of the invention shown in FIG. 1, the first cooling zone 60 and the second cooling zone 70 are connected to one another via conduits 61 and 72, such that the cooling medium first goes into the second cooling zone 70 via conduit 71, where it absorbs a portion of the heat released within the oxidation reactor. Then the cooling medium goes into the first cooling zone 60 via conduit 72, where it absorbs a further portion of the heat released within the oxidation reactor. Finally, the cooling medium is discharged from the first cooling zone via conduit 62. The overall result is therefore a flow direction of the cooling medium in countercurrent relative to the flow direction of the reactant and product gas streams of the oxidation reactor. By means of a pump and a cooler (both not shown), a cooling media circuit is formed. In addition, in one example, an additional, cold cooling media stream may be introduced into the first cooling zone 60 via a conduit (not shown). In addition, in one example, an additional, warm cooling media stream may be discharged from the second cooling zone 60 via a conduit (not shown). The configurations according to the two latter examples additionally increase options for use and improve control of the oxidation reactor temperature.

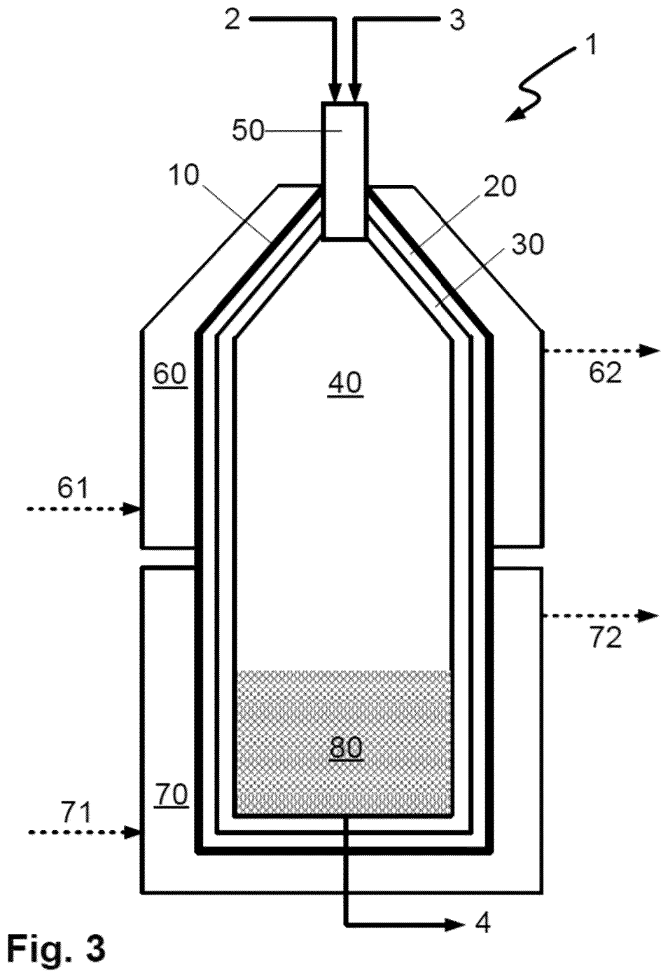

FIG. 3 shows a schematic diagram of a third configuration of the oxidation reactor according to the invention. With regard to the configuration of the cooling zones, this configuration corresponds to the configuration shown in FIG. 1, except that the oxidation reactor is an autothermal reformer containing a bed 80 of an ATR catalyst in the lower portion of the reactor chamber 40. For operation of the oxidation reactor as an autothermal reformer, as well as the oxygen-containing oxidant, steam is introduced into the oxidation reactor via conduit 2 or conduit 3 or a separate conduit which is not shown, or a combination of at least two of these conduits.

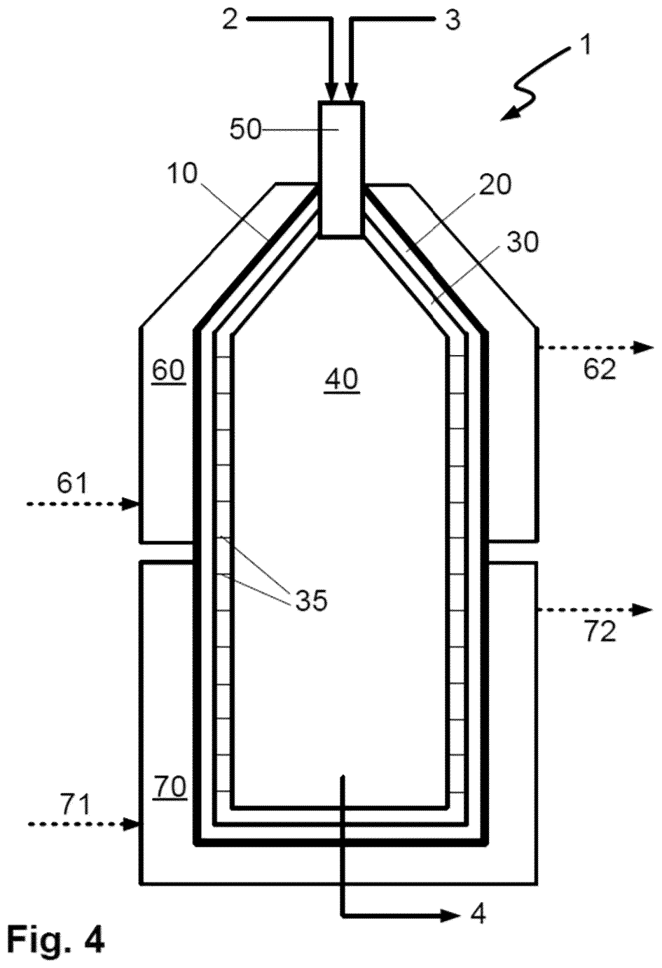

FIG. 4 shows a schematic diagram of a fourth configuration of the oxidation reactor according to the invention. With regard to the configuration of the cooling zones, this configuration corresponds to the configuration shown in FIG. 1, except that the second protective layer 30 is equipped with periodically circumferential expansion gaps 35 and/or expansion gaps in longitudinal direction (not shown). This provision of the oxidation reactor with expansion gaps is also applicable to the configurations shown in FIGS. 1, 2 and 3 and is advantageous. Provision with expansion gaps may also extend to the upper frustoconical portion and the outlet-side portion of the second protective layer (both not shown).

In further examples, in the oxidation reactors 1 shown in FIGS. 1, 2, 3 and 4, the first and second cooling zones 60, 70 are operable separately and can be assembled and disassembled separately (not shown). As a result, in one example, operation of the oxidation reactor can continue if, for example, merely an inspection or repair at a particular point in the reactor shell is required. Operation of the oxidation reactor 1 can continue over the duration of the inspection or repair measures, such that production shutdowns are avoided.

In further examples, in the oxidation reactors 1 shown in FIGS. 1, 2, 3 and 4, the flow of the cooling medium through the first and second cooling zones 60, 70 is controllable separately (not shown). In this way, finer reaction to local differences in the heat budget of the oxidation reactor is possible, and so the result is improved temperature control of the oxidation reactor.

In further examples, in the oxidation reactors 1 shown in FIGS. 1, 2, 3 and 4, the pressure of the cooling medium in the first and second cooling zones 60, 70 is controllable separately (not shown). In this way too, finer reaction to local differences in the heat budget of the oxidation reactor is possible, and so the result is improved temperature control of the oxidation reactor. For example, it would be possible to operate one cooling zone 60 or 70 with boiling cooling medium, which results in particularly intense heat transfer, while the cooling medium in a further cooling zone remains as a monophasic fluid.

In further examples, in the oxidation reactors 1 shown in FIGS. 1, 2, 3 and 4, a common first and second fluid cooling medium is used, which flows through the first and second cooling zones 60, 70 (not shown). The use of a common cooling medium simplifies the configuration of the coolant circuit. In one example, the first and second cooling zones 60, 70 are embedded into a common cooling media circuit, and the cooling medium flows through them in parallel or sequentially.

In further examples, in the oxidation reactors 1 shown in FIGS. 1, 2, 3 and 4, the first and second cooling zones 60, 70 are fluidically connected, and the mass flow of the cooling medium through the first and second cooling zones 60, 70 is controllable separately (not shown). This configuration combines the advantages of a simplified coolant circuit with improved temperature control of the oxidation reactor.

In further examples, in the oxidation reactors 1 shown in FIGS. 1, 2, 3 and 4, a cooling apparatus for intermediate cooling of the cooling medium is present between the first and second cooling zones (not shown). This configuration is advantageous when the cooling media in both cooling zones are to remain monophasic fluids, but high removal of heat from the first cooling zone is nevertheless required.

In further examples, in the oxidation reactors 1 shown in FIGS. 1, 2, 3 and 4, more than two cooling zones are present (not shown). Although this configuration increases construction complexity, even finer reaction is possible in this way to local differences in the heat budget of the oxidation reactor, so as to result in a further improvement in temperature control of the oxidation reactor.

In further examples, in the oxidation reactors 1 shown in FIGS. 1, 2, 3 and 4, a common cooling medium is used, which flows through all cooling zones 60, 70, etc. (not shown), preferably with use of water as common cooling medium. Water is available in sufficient volume and quality at most locations, is nontoxic, and has advantages if cooling is to be implemented in the form of evaporative cooling in the particular cooling zone. The use of a common cooling medium additionally simplifies the configuration of the coolant circuit.

In further examples, in the oxidation reactors 1 shown in FIGS. 1, 2, 3 and 4, the inlet end is of frustoconical configuration and has a gastight connection to the burner 50 at its narrow end and has a gastight connection to the reactor shell 10 at its wide end.

In further examples, in the oxidation reactors 1 shown in FIGS. 1, 2, 3 and 4, the thermal conductivity of the first protective layer is lower than the thermal conductivity of the second protective layer. What is advantageous about this configuration is the attenuating effect of the smaller thermal conductivity of the first protective layer on the heating of the reactor shell, especially when one or more cooling zones are not in operation.

In further examples, in the oxidation reactors 1 shown in FIGS. 1, 2, 3 and 4, a multitude of expansion gaps (not shown) are present within the first and/or second protective layer, and are preferably distributed uniformly over the circumference and/or length of the first and/or second protective layer 20, 30. In this way, damage to the protective layers as a result of thermal expansion is avoided.

In further examples, in the oxidation reactor 1 shown in FIG. 1, an expansion gap in the form of an annular gap is disposed between the reactor shell and the first protective layer and/or between the first protective layer and the second protective layer. In this way, damage to the protective layers as a result of thermal expansion is avoided.

In further examples, in the oxidation reactors 1 shown in FIGS. 1, 2, 3 and 4, the wall thicknesses and/or thermal conductivities of the first and second protective layers 20, 30 are chosen such that the temperature of the reactor shell at its outer surface is between 180 and 300° C., preferably between 200 and 250° C., if no cooling medium is passed through one or more cooling zones. These stated temperatures are advantageous because energy consumption, material stress and heat exposure of operating personnel are reduced.

In further examples, in the oxidation reactors 1 shown in FIGS. 1, 2, 3 and 4, water is used as a common cooling medium and the wall thicknesses and thermal conductivities of the first and second protective layers 20, 30 and the mass flow of the common cooling medium through the cooling zones are chosen such that the temperature of the cooling medium exiting from the cooling zones is less than 100° C. This limiting temperature is advantageous because energy consumption, material stress and heat exposure of operating personnel are reduced. In the case of disassembly of one or more cooling zones, in this way, the risk of burning for operating personnel as a result of unintentional contact with the exposed reactor shell is reduced.

In further examples, the oxidation reactors 1 shown in FIGS. 1, 2 and 4 are used for the noncatalytic partial oxidation (POX) of a feed stream containing hydrocarbons to give a product stream containing hydrogen and carbon oxides.

In further examples, the oxidation reactors 1 shown in FIGS. 1, 2 and 4 are used for the partial oxidation of an ammonia-containing feed stream to a product stream containing hydrogen and nitrogen.

In a further example, the oxidation reactor shown in FIG. 3 is used for the autothermal reforming (ATR) of a feed stream containing hydrocarbons to a product stream containing hydrogen and carbon oxides.

In a further example, the oxidation reactor shown in FIG. 3 is used for the autothermal reforming (ATR) of an ammonia-containing feed stream to a product stream containing hydrogen and nitrogen.

Further working examples of the invention include a process for producing a product stream containing hydrogen and carbon oxides from a feed stream containing hydrocarbons and an oxygen-containing oxidant stream, comprising the following steps:
(a) providing an oxidation reactor according to Claims 1 to 15;
(b) introducing the feed stream containing hydrocarbons, the oxygen-containing oxidant stream and an optional moderator stream via the burner into the reaction chamber;
(c) converting the feed stream containing hydrocarbons and the oxygen-containing oxidant stream in the burner and/or in the reaction chamber under conditions for noncatalytic partial oxidation (POX);
(d) discharging the product stream containing hydrogen and carbon oxides via the outlet.

Further working examples of the invention include a process for producing a product stream containing hydrogen and carbon oxides from a feed stream containing hydrocarbons and an oxygen-containing oxidant stream, comprising the following steps:
(a) providing an oxidation reactor according to Claim 16;
(b) introducing the feed stream containing hydrocarbons, the oxygen-containing oxidant stream and an optional moderator stream via the burner into the reaction chamber;
(c) converting the feed stream containing hydrocarbons and the oxygen-containing oxidant stream in the burner and/or in the reaction chamber and/or in the catalyst bed under conditions for autothermal reforming (ATR);
(d) discharging the product stream containing hydrogen and carbon oxides via the outlet.

Further working examples of the invention include a process for producing a product stream containing hydrogen and nitrogen from an ammonia-containing feed stream and an oxygen-containing oxidant stream, comprising the following steps:
(a) providing an oxidation reactor according to Claims 1 to 15;
(b) introducing the ammonia-containing feed stream, the oxygen-containing oxidant stream and an optional moderator stream via the burner into the reaction chamber, and optionally introducing a steam stream into the reaction chamber;
(c) converting the ammonia-containing feed stream and the oxygen-containing oxidant stream in the burner and/or in the reaction chamber under conditions for noncatalytic partial oxidation of ammonia;
(d) discharging the product stream containing hydrogen and nitrogen via the outlet.

Alterations to the above-described embodiments or configurations of the present disclosure are possible without departing from the scope of the present disclosure defined by the accompanying claims. Expressions such as “including”, “comprising”, “containing”, “have” and “is” that are used for description and claiming of the present disclosure shall be considered to be non-exclusive, meaning that they allow for the presence of articles, components or elements that are not explicitly described. References to the singular shall be considered also to refer to the plural in the absence of explicit indications to the contrary in the particular case.

### LIST OF REFERENCE NUMERALS

1 oxidation reactor
2 conduit
3 conduit
4 conduit (outlet)
10 reactor shell
20 first protective layer
30 second protective layer
35 expansion gaps
40 void volume (reactor chamber)
50 burner
60 first cooling zone
61 cooling water conduit
62 cooling water conduit
70 second cooling zone
71 cooling water conduit
72 cooling water conduit
80 ATR catalyst bed

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1. An oxidation reactor for partial oxidation of a feed stream with an oxygen-containing oxidant stream to give a hydrogen-containing product stream, comprising:
(a) a pressure-rated reactor shell comprising a metallic material, that is cylindrical over part of its length, has a longitudinal axis, and has a first wall thickness;
(b) a first protective layer composed of a first refractory material having a second wall thickness, mounted within the reactor shell;
(c) a second protective layer composed of a second refractory material having a third wall thickness, mounted within the first protective layer;
(d) a void volume as reaction chamber disposed within the second protective layer;
(e) an inlet for the feed stream, mounted at an inlet end of the reactor shell, where the inlet is configured as a burner through which the feed stream, the oxygen-containing oxidant stream and a moderator stream may be introduced into the reaction chamber;
(f) an outlet mounted at an outlet end of the reactor shell, through which the product stream may be discharged;
(g) a first cooling zone mounted on and surrounding the reactor shell, by means of which a first section of the reactor shell is coolable by means of a first fluid cooling medium;
(h) a second cooling zone mounted on and surrounding the reactor shell, by means of which a second section of the reactor shell is coolable by means of a second fluid cooling medium.

2. The oxidation reactor according to claim 1, wherein the first and second cooling zones are operable separately and may be assembled and disassembled separately.

3. The oxidation reactor according to claim 1, wherein the flow of the cooling medium through the first and second cooling zones is controllable separately.

4. The oxidation reactor according to claim 1, wherein the pressure of the cooling medium in the first and second cooling zones is controllable separately.

5. The oxidation reactor according to claim 1, wherein a common first and second fluid cooling medium is used, which flows through the first and second cooling zones.

6. The oxidation reactor according to claim 1, wherein the first and second cooling zones are in fluid connection, and in that the mass flow of the cooling medium through the first and second cooling zones is controllable separately.

7. The oxidation reactor according to claim 1, wherein a cooling apparatus for intermediate cooling of the cooling medium is present between the first and second cooling zones.

8. The oxidation reactor according to claim 1, wherein more than two cooling zones are present.

9. The oxidation reactor according to claim 1, wherein a common cooling medium that flows through all cooling zones is used.

10. The oxidation reactor according to claim 1, wherein the inlet end is of frustoconical configuration and has a gastight connection to the burner at its narrow end and has a gastight connection to the reactor shell at its wide end.

11. The oxidation reactor according to claim 1, wherein the thermal conductivity of the first protective layer is lower than the thermal conductivity of the second protective layer.

12. The oxidation reactor according to claim 1, wherein a multitude of periodically circumferential expansion gaps and/or of expansion gaps in longitudinal direction are present within the first and/or second protective layer.

13. The oxidation reactor according to claim 1, wherein an expansion gap in the form of an annular gap is disposed between the reactor shell and the first protective layer and/or between the first protective layer and the second protective layer.

14. The oxidation reactor according to claim 1, wherein the wall thicknesses and/or thermal conductivities of the first and second protective layers are chosen such that the temperature of the reactor shell at its outer surface is between 180 and 300° C. if no cooling medium is passed through one or more cooling zones.

15. The oxidation reactor according to claim 1, wherein water is used as a common cooling medium and in that the wall thicknesses and thermal conductivities of the first and second protective layers and the mass flow of the common cooling medium through the cooling zones are chosen such that the temperature of the cooling medium exiting from the cooling zones is less than 100° C.

16. The oxidation reactor according to claim 1, wherein a portion of the reaction chamber is filled with a bed of a solid particulate catalyst active in respect of autothermal reforming.

17. A process for producing a product stream containing hydrogen and carbon oxides from a feed stream containing hydrocarbons and an oxygen-containing oxidant stream, comprising:
(a) providing an oxidation reactor according to claim 1;
(b) introducing the feed stream containing hydrocarbons, the oxygen-containing oxidant stream and a moderator stream via the burner into the reaction chamber;
(c) converting the feed stream containing hydrocarbons and the oxygen-containing oxidant stream in the burner and/or in the reaction chamber under conditions for noncatalytic partial oxidation;
(d) discharging the product stream containing hydrogen and carbon oxides via the outlet.

18. A process for producing a product stream containing hydrogen and carbon oxides from a feed stream containing hydrocarbons and an oxygen-containing oxidant stream, comprising:
(a) providing an oxidation reactor according to claim 16;
(b) introducing the feed stream containing hydrocarbons, the oxygen-containing oxidant stream and a moderator stream via the burner into the reaction chamber;
(c) converting the feed stream containing hydrocarbons and the oxygen-containing oxidant stream in the burner and/or in the reaction chamber and/or in the catalyst bed under conditions for autothermal reforming;
(d) discharging the product stream containing hydrogen and carbon oxides via the outlet.

19. A process for producing a product stream containing hydrogen and nitrogen from an ammonia-containing feed stream and an oxygen-containing oxidant stream, comprising the following steps:
(a) providing an oxidation reactor according to claim 1;
(b) introducing the ammonia-containing feed stream, the oxygen-containing oxidant stream and a moderator stream via the burner into the reaction chamber, and introducing a steam stream into the reaction chamber;
(c) converting the ammonia-containing feed stream and the oxygen-containing oxidant stream in the burner and/or in the reaction chamber under conditions for noncatalytic partial oxidation of ammonia;
(d) discharging the product stream containing hydrogen and nitrogen via the outlet.
